(19) United States
(12) Patent Application Publication
(10) Pub. No.: US 2016/0328672 A1
(43) Pub. Date: Nov. 10, 2016

(54) ACTIVITY MONITORING SYSTEM AND METHOD

(71) Applicant: Wal-Mart Stores, Inc., Bentonville, AR (US)

(72) Inventors: Donald R. High, Noel, MO (US); Brian Gerard McHale, Oldham (GB)

(21) Appl. No.: 15/148,211

(22) Filed: May 6, 2016

Related U.S. Application Data
(60) Provisional application No. 62/158,628, filed on May 8, 2015.

(51) Int. Cl. G06Q 10/06; H04W 4/04; G06Q 30/00

(52) U.S. Cl. CPC G06Q 10/063114; G06Q 30/018; H04W 4/04

(57) ABSTRACT

Provided are a system and method for monitoring an activity performed by a member of staff in a retail environment. A compliance activity database stores a list of activities to be performed by the member of staff and location information associated with each activity on the list. An in-store device displays an instruction to perform an activity from the list of activities, carried by the member of staff whilst performing the activity. A location determiner determines a location of the in-store device whilst the member of staff carries out the activity, generates location information based on the determined location, and stores the location information in the compliance activity database. The location information serves as evidence that the activity has been completed.

### FIELD

The present concepts relate generally to activity monitoring systems and methods.

### BACKGROUND

A modern retail store must comply with numerous laws, rules and regulations in order to operate safely and legally. For example, a store must ensure that the correct price is displayed along with items on sale, such as on a label displayed on shelf-edge or on the items themselves. A store selling foodstuffs must ensure that any foodstuffs sold and displayed are within their expiry date. Any products which are deemed defective by the manufacturer or supplier may be required to be “recalled” and therefore removed from display within the retail store. Furthermore, health and safety laws and regulations oblige a retailer to ensure that the store provides a safe environment for customers, free of any hazards which may cause injury to the customer.

In order to comply with such obligations, a variety of regular activities must be performed. For example, display units should be checked to ensure no expired foodstuffs are on display, fire doors should be checked to ensure that they operate correctly, and so on. These regular activities which ensure compliance with relevant legal obligations are referred to in the art as “compliance activities”. Not only must a retail store carry out such compliance activities, it is also usually required to record that the fact that the activity has indeed been carried out, along with any relevant outcome of the task. The record is retained so that the retail store can demonstrate to the relevant authorities that it fully complies with the relevant legal obligations. Returning to the example of the fire door, a retail store may, for example, record the time at which the fire door was checked, who was responsible for checking the fire door, whether the fire door was operating correctly, and if not, what remedial action was taken.

Equally, in order for a retail store to operate efficiently, remain tidy and provide an environment conducive to the sale of items, a number of other tasks must also be regularly performed. For instance, display units must be restocked; the retail environment must be cleaned and tidied, and so on. These other regular activities are also referred to in the art as compliance activities, in that they ensure that the retail store is complying with the retailer's internal policies regarding store operation. There is also a desire to ensure that these tasks have been carried out appropriately, and therefore there are typically similar requirements in terms of the recording that the tasks have been completed.

In one example, the scheduling and recording of compliance activities is carried out largely on pen and paper. For example, a member of staff is instructed to perform a particular activity at a particular interval, and a standard form is provided in which the member of staff notes the time at which an activity was actually performed, and indicates any remedial action required. However, a number of difficulties arise with such a manual system. For instance, it may be difficult to easily identify when a compliance activity has been missed from a manually completed sheet, especially when the handwriting of a member of staff is unclear. Furthermore, the completion of such paper forms may be time consuming, and the forms themselves may be easily misplaced. Even if the forms are correctly completed, the information on the forms must then be stored, either by filing them in filing cabinets, scanning the forms and storing them electronically, or manually inputting the information into a computer.

It is an aim of the present inventive concepts to address at least some of the above difficulties, or other difficulties which will be appreciated from the description below. It is a further aim of the present inventive concepts to provide convenient, accurate and cost effective systems and methods for monitoring compliance activities in a retail store.

### SUMMARY

According to some aspects, there is provided an apparatus and method as set forth in the appended claims. Other features will be apparent from the dependent claims, and the description which follows.

In one embodiment, provided is a system for monitoring an activity performed by a member of staff in a retail environment, comprising: a compliance activity database, configured to store a list of activities to be performed by the member of staff and location information associated with each activity on the list; an in-store device, configured to display an instruction to perform an activity from the list of activities, and to be carried by the member of staff whilst performing the activity, and a location determiner, configured to determine a location of the in-store device whilst the member of staff carries out the activity, generate location information based on the determined location and store the location information in the compliance activity database, wherein the location information serves as evidence that the activity has been completed.

Suitably, the system comprises at least one sensor, configured to capture environment data of the retail environment, and a compliance verifier, configured to determine whether the activity has been completed by the member of staff based on the environment data, and generate compliance verification information based on the determined activity completion, wherein the compliance activity database is further configured to store compliance verification information associated with each activity on the list.

Suitably, the compliance verifier is configured to determine whether the activity has been completed by comparing the captured environment data to stored environment data, wherein the stored environment data comprises baseline environment data representing the retail environment after completion of the activity.

Suitably, the or each sensor comprises a 3D scanner, and the environment data comprises a 3D model of the retail environment.

Suitably, the or each sensor comprises a camera, and the environment data comprises an image of the retail environment.

Suitably, the or each sensor comprises a laser distance sensor, and the environment data comprises a distance measurement.

Suitably, the compliance verifier is configured to determine a position or configuration of an object in the retail environment, and the compliance verification information comprises the determined position or configuration of the object before the activity is performed and the determined position or configuration of the object after the activity is performed.

Suitably, the in-store device is configured to receive, by a user input, a completion confirmation indicating that the activity has been completed by the member of staff, and the compliance verifier is configured to determine whether the activity has been completed upon receipt of the completion confirmation.

Suitably, if the compliance verifier determines that the activity has not been completed, the in-store device is configured to display a non-compliance alert which indicates the activity has not been completed.

Suitably, the system further comprises a supervisor device configured to be carried by a store supervisor, wherein, if the compliance verifier determines that the activity has not been completed, the supervisor device is configured to display a non-compliance alert which indicates the activity has not been completed.

Suitably, the activity is a compliance activity, in which the member of staff ensures that that the retail environment complies with a relevant safety rule or regulation.

Suitably, the location determiner comprises: a plurality of emitters operable to emit modulated light, and a receiver operable to measure a quantity of modulated light received from each respective emitter, so as to determine the location, wherein the in-store device comprises the receiver.

Suitably, the location information comprises a plurality of locations determined whilst the member of staff carries out the activity.

Suitably, the plurality of locations are determined at pre-determined time intervals.

Suitably, the in-store device is configured to receive, by a user input, a completion confirmation indicating that the activity has been completed by the member of staff, and the compliance activity database is configured to store the completion confirmation.

Suitably, the in-store device is configured to receive, by a user input, an initiation confirmation indicating that the activity has been started by the member of staff, and the compliance activity database is configured to store the initiation confirmation.

In one embodiment, provided is a method of monitoring an activity performed by a member of staff in a retail environment, comprising: storing a list of activities to be performed by the member of staff;displaying an instruction to perform an activity from the list of activities on an in-store device carried by the member of staff whilst performing the activity; determining a location of the in-store device whilst the member of staff carries out the activity and generating location information based on the determined location, and storing the location information of the in-store device, wherein the location information serves as evidence that the activity has been completed.

Suitably the method further comprises: capturing environment data of the retail environment; determining whether the activity has been completed by the member of staff based on the environment data; generating compliance verification information based on the determined activity completion, and storing the generated compliance verification information.

Suitably, the determining whether the activity has been completed comprises: comparing the captured environment data to stored environment data, wherein the stored environment data comprises baseline environment data representing the retail environment after completion of the activity.

Suitably, the determining whether the activity has been completed comprises: determining a position or configuration of an object in the retail environment, wherein the compliance verification information comprises the determined position or configuration of the object before the activity is performed and the determined position or configuration of the object after the activity is performed.

### BRIEF DESCRIPTION OF THE DRAWINGS

For a better understanding of the inventive concepts, and to show how embodiments of the same may be carried into effect, reference will now be made, by way of example, to the accompanying diagrammatic drawings in which:

FIG. 1 is a schematic view of a retail store in which an exemplary activity monitoring system may operate;

FIG. 2 is a schematic view of an exemplary activity monitoring system;

FIGS. 3A, 3B, 3C and 3D are each an exemplary user interface of the in-store device of an exemplary activity monitoring system;

FIG. 4 is a flowchart of an exemplary method of monitoring an activity performed by a member of staff in a retail environment; and

FIGS. 5A and 5B are diagrams illustrating baseline and captured environment data used by a compliance verifier of an exemplary activity monitoring system.

### DETAILED DESCRIPTION

In overview, embodiments display an instruction to perform a compliance activity on a portable device carried by a member of retail store staff, and then determines and records the location of the member of staff whilst they carry out the compliance activity. In some embodiments data from sensors, such as scanners, cameras or laser distance sensors, is used to verify whether the compliance activity is completed. As a result, evidence is captured which demonstrates that the compliance activity has been properly completed.

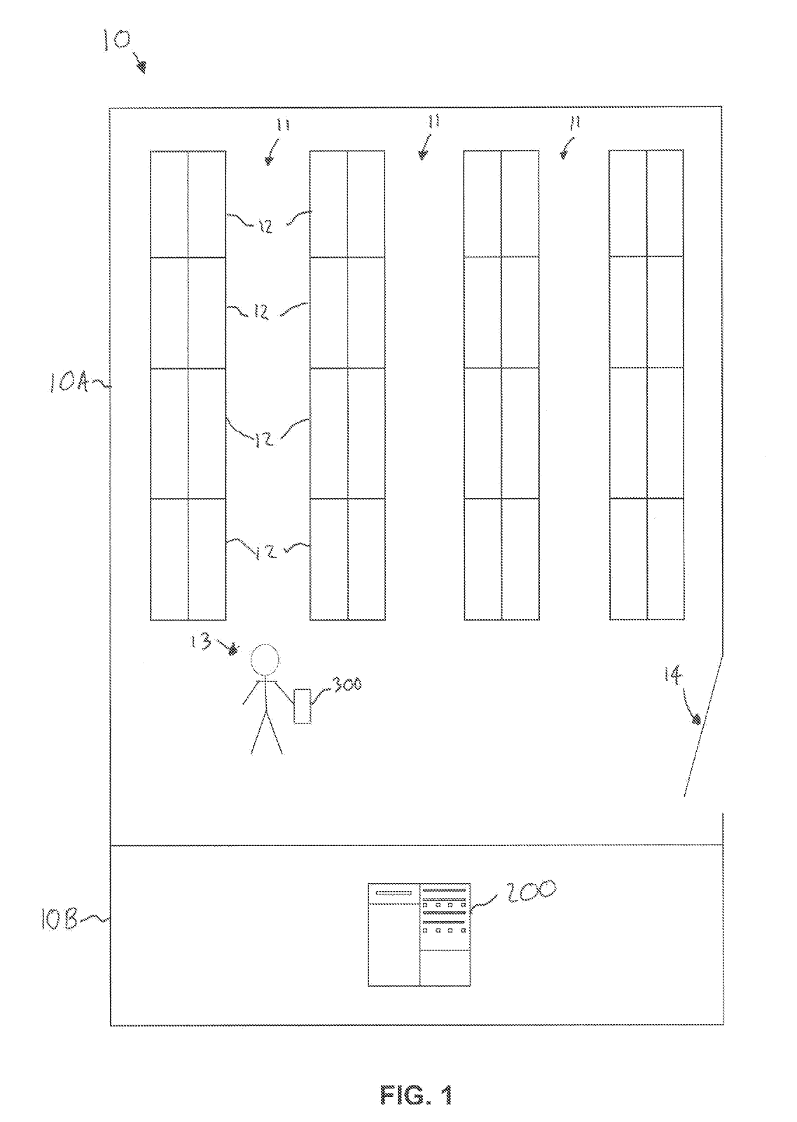

FIG. 1 shows a schematic view of a physical environment in which embodiments of may operate. In one example, the physical environment is a retail store 10. The retail store 10 typically comprises a sales area 10A, in which goods are displayed for customers to purchase, and an operational area 10B, in which further stock may be held, and in which infrastructure for the operation and maintenance of the retail store is installed. In one example, the operational area 10B includes a server 200, which will be described in further detail below. It will be understood by those skilled in the art that the retailer's computer network may in practice comprise hundreds of stores with various local servers linked to one or more central control computers operated by the retail, e.g. in the head office of the retailer.

The sales area 10a typically includes a plurality of aisles 11, wherein each aisle further comprises a plurality of storage units 12. The storage units 12 are arranged to hold products for sale in the retail store 10, and may comprise a plurality of shelves (not shown). It will be understood that a variety of storage units 12 may be employed, including storage units arranged on the end of aisles, arranged to stand freely, and arranged to refrigerate the products held therein. Typically, customers (not shown) move around the sales area 10A, progressing up and down the aisles 11 and selecting the products that they wish to purchase. Once they have selected the products they desire, they pay for the products at a checkout (not shown).

The sales area 10A and the operational area 10B also typically include various pieces of physical infrastructure which may require regular inspection to ensure that they remain in good working order and/or to ensure compliance with relevant health and safety legislation. For example, the retail store 10 may include a fire exit door 14, through which staff and customers may exit the building in the case of fire.

FIG. 1 also shows an in-store device 300, operated by a user. In the example embodiments, the user is a member of retail store staff 13. The in-store device 300 is described in further detail below.

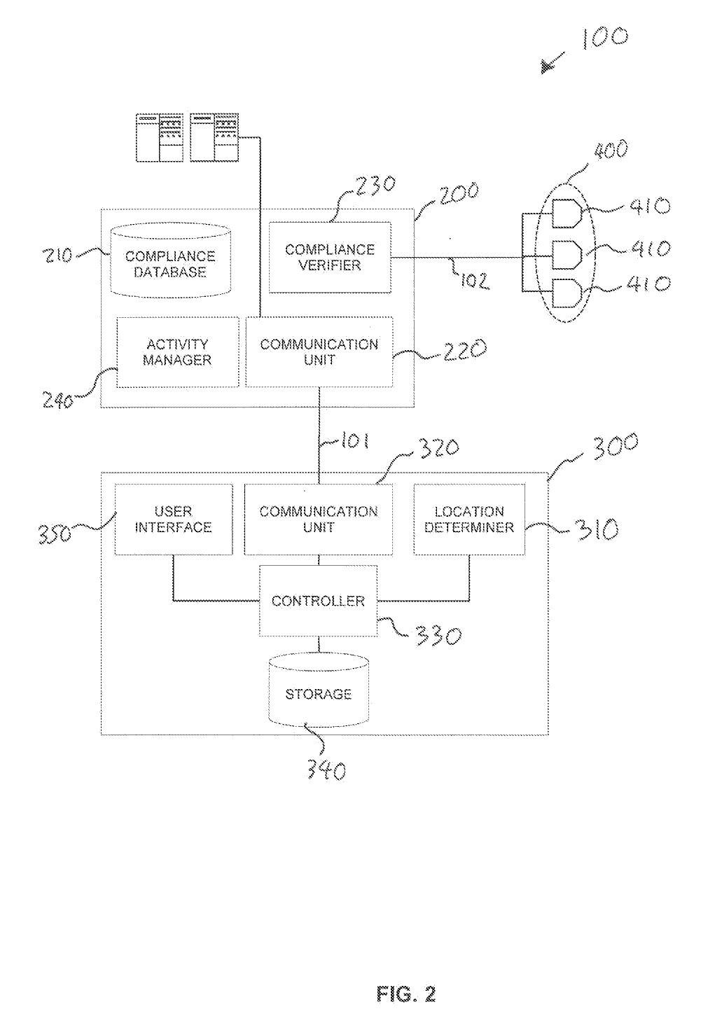

FIG. 2 shows a schematic diagram of an activity monitoring system 100 in accordance with an example embodiment.

In one example, the system 100 comprises a compliance activity database 210 held on a server 200, an in-store device 300 and a location determiner 310 configured to determine a location of the in-store device 300. The compliance activity database 210 stores a list of compliance activities to be performed in the retail store 10, and information regarding the completion of each compliance activity.

In one example, the server 200 and the in-store device 300 are linked by a communication network 101. The communication network 101 may take any suitable form, including secure wired and/or wireless communication links, as will be familiar to those skilled in the art. In further examples, the server 200 may be located off-site, for example in a central or regional data processing site, rather than in the operational area 10b. In such example, the communication network 101 may include a wide area network, such as a private leased line and/or the Internet. The server 200 comprises a communication unit 220, which is configured to manage the communications over the network 101 to/from the in-store device 300.

In one example, the communication unit 220 may also manage communications between the server 200 other connected server computers operated by the retailer, thereby forming part of a corporate server network. In one example, information for updating the compliance activity database 210 is received from these other servers, e.g. a server at head office. Accordingly, the list of compliance activities to be performed in the retail store 10 may be updated to reflect changes in legislation or store policy.

Conveniently, the compliance activity database 210 is held on the server 200 so as to be accessible in use by the in-store device 300. However, it will be understood by those skilled in the art that compliance activity database 210 could instead by stored locally on the in-store device 300, e.g. by caching all or part of the compliance activity database 210.

The server 200 comprises an activity manager 240 configured to control the server 300. In one example, the activity manager 240 is operable to inspect the compliance activity database 210 to establish that a compliance activity is due to be carried out by a member of staff 13. In one example, the activity manager 240 is operable to transmit a message to the in-store device 300 comprising an instruction indicating that the compliance activity should be carried out.

In one example, the activity manager 240 is operable to receive a message from the in-store device 300 confirming that the compliance activity has been initiated, and subsequently store the confirmation in the compliance activity database 210. In one example, the activity manager 240 is operable to receive a message from the in-store device 300 confirming that the compliance activity has been initiated, and subsequently store the confirmation in the compliance activity database 210. In one example, the activity manager 240 is configured to generate an alert if the compliance activity has not been completed within a certain duration, for example from the transmission of the instruction or the receipt of the confirmation that the compliance activity has been initiated. The activity manager 240 is configured to transmit the generated alert to the in-store device 300, and/or any other relevant devices connected to the server 200 via the communication network 101.

The in-store device 300 is a computing device configured to be operated by a member of retail store staff 13. The in-store device 300 may be a portable or wearable device adapted to be carried or worn by a user whilst in use. In one example, the in-store device 300 is one of a tablet computer, a smart phone, a smart watch or smart glasses.

In one example, the in-store device 300 includes a controller 330, a storage 340, a communication unit 320, a user interface 350.

The controller 330 is operable to control the in-store device 300, and may take the form of a processor. The storage 340 is operable to store, either transiently or permanently, any relevant data required for the operation and control of the in-store device 300. The communication unit 320 is operable to manage communications with the server 300 over the communication network 101.

The user interface 350 is configured to output information to a user and to receive inputs from a user via one or more interfaces. In one example, the user interface 350 comprises a display, operable to display images and text to the user. In one example, the display may be integral to the in-store device 300, but it is not limited thereto. In examples where the in-store device 300 comprises smart glasses, the display may be a Heads-Up Display on the glasses or otherwise projected into the field of view of the user.

In one example, the user interface 350 comprises a means of receiving the user input, such as a keyboard or a touch-screen unit. In one example, the user interface 350 is a touch-screen interface, in which the display and means of receiving user input are integrated. In further example, the user interface 350 may receive user input by means of voice activation, gesture recognition or any other suitable means. The user interface 350 may also be operable to receive user input from a combination of these sources.

The user interface 350 is particularly configured to output information and to receive input relating to compliance activities. In one example, the user interface 350 is configured to display an instruction to perform a compliance activity. In one example, the user interface 350 is configured to receive user input indicating that the member of staff 13 has initiated the compliance activity. In one example, the user interface 350 is configured to receive user input indicating that the member of staff 13 has completed the compliance activity. The input and output of the user interface 350 will be described in further detail below.

The in-store device 300 further comprises the location determiner 310, configured to determine the location of the in-store device 300 within the retail store 10. The location determiner 310 may use a suitable indoor positioning system to establish the position of the in-store device 300. The determined location may comprise co-ordinates representing a position of the device 300 on a map of the retail store 10.

In one example, the indoor positioning system may be based on modulated visible light. Particularly, a plurality of LED lights configured to emit modulated visible light may be installed within the retail store 10. The location determiner 310 may comprise one or more photo receivers, e.g. cameras, operable to receive the modulated visible light. In such an example, the location determiner 310 is configured to determine the location based on the relative quantity of light received from one or more of the plurality of LED lights. In one example, the LED lights are light fixtures produced by ByteLight™.

In one example, the indoor positioning system may comprise locator beacons, for example Bluetooth® Low Energy beacons. The location determiner 310 may determine location using one or more of the locator beacons, for example based on relative signal strength, or based on each beacon covering a certain predetermined area of the retail store 10.

In further examples, the indoor positioning system may employ the Global Positioning System (GPS), Wi-Fi, Near-Field Communication (NFC) or any other suitable positioning technology. It will be understood that the location determiner 310 may employ a plurality of positioning technologies, e.g. depending on the level of granularity required, or to provide a fall back in case of technical problems.

Although the location determiner 310 has been described as part of the in-store device 300, it will be understood that the location determiner 310 could instead be provided as part of the server 200.

In one example, the location determiner 310 is configured to determine the location of the in-store device 300 periodically, for example at predetermined time intervals.

In one example, the location determiner 310 is configured to determine the location of the in-store device 300 whilst the member of staff 13 carries out the compliance activity. For example, the location determiner 310 may be configured to begin determining the location of the in-store device 300 upon receipt of user input indicating that the member of staff 13 has initiated the compliance activity. The location determiner 310 may be further configured to cease the determination of the location of the in-store device 300 upon receipt of user input indicating that the member of staff 13 has completed the compliance activity.

Accordingly, the location determiner 310 may generate location information based on the determined location of the in-store device 300, which provides a record of the movements of the member of staff 13 whilst undertaking the compliance activity. In one example, the location information comprises a list of co-ordinates representing the position of the in-store device 300 over time.

In use, the activity manager 240 queries the list of compliance activities held in compliance activity database 240 to ascertain whether any compliance activities are due to be undertaken. In one example, the activity manager 240 queries the compliance activity database at predetermined intervals.

If the activity manager 240 determines that a compliance activity is due to be undertaken, the activity manager 240 generates a message containing an instruction to perform that activity, and transmits the message to the in-store device 300.

It will be understood by those skilled in the art that, in some examples, the system 100 may comprise a plurality of in-store devices 300 each operated by a respective member of store staff. In such an example, the activity manager 240 may transmit the message to a particular in-store device 300, based on one or more rules. For example, the message may be transmitted to a predetermined member of staff 13 with particular responsibility for the activity, or to the member of staff 13 most proximate to the area in which the activity is to be carried out, or to a member of staff 13 with the lowest current workload.

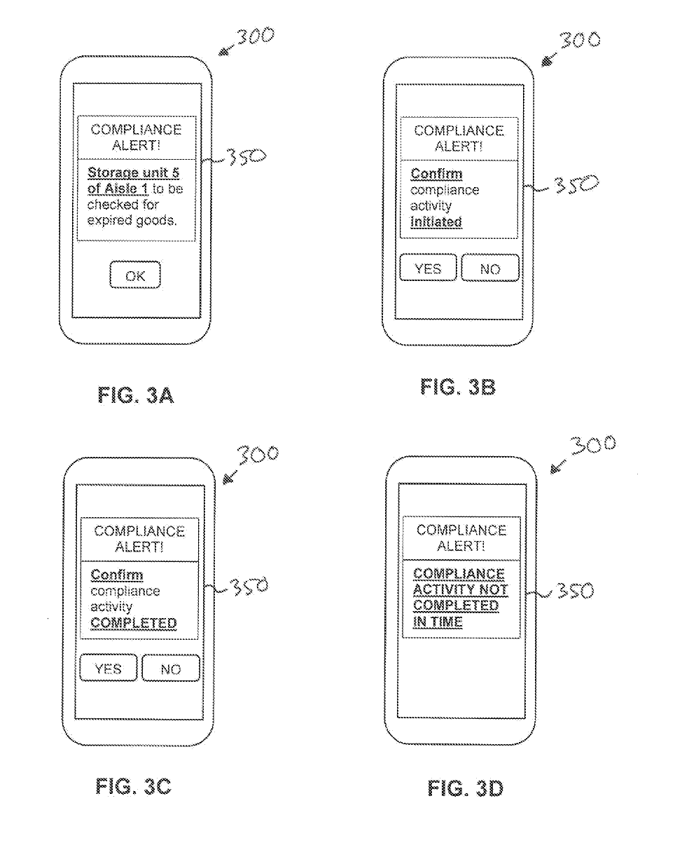

Next, upon receipt of the instruction, the in-store device 300 displays the instruction on the user interface 350. FIG. 3A shows an example of the instruction being displayed on the user interface 350. In the particular example shown in FIG. 3A, the instruction relates to a compliance activity of ensuring that a particular storage unit 12 of a particular aisle 11 of the retail store 10 is inspected to remove any goods which have passed their expiry date. It will be understood that the instruction could instead to relate to a wide variety of compliance activities within the retail store 10, including, but not limited to, the removal of recalled stock, checking fire doors and other safety measures within store, re-stocking and tidying storage units, and so on.

Next, the member of staff 13 operating the in-store device 300 confirms receipt of the instruction, for example by pressing an “OK” button.

Next, the location determiner 310 determines the location of the in-store device 300 whilst the member of staff 13 carries out the compliance activity. The location determiner 310 generates location information based on the determined location. For example, the location information may comprise a plurality of determined locations of the in-store device 300 whilst the activity is carried out, thereby resulting in a record of the movements of the member of staff 13. In one example, the location determiner 310 determines the location of the in-store device 300 at predetermined time intervals—e.g. once every 5, 10, 30 or 60 seconds.

In one example, the location determiner 310 begins determining the location of the in-store device 300 upon confirmation of receipt of the instruction, e.g. when the member of staff 13 presses the “OK” button of FIG. 3A.

In further examples, the location determiner 310 begins determining the location of the in-store device 300 upon receipt of confirmation that the activity has been initiated. FIG. 3B shows an example of the user interface 350 displaying a screen which is configured to receive user input confirming that the compliance activity has been initiated. In the example shown in FIG. 3B, the member of staff 13 presses the “YES” button to confirm that they are beginning to perform the compliance activity. In one example, the location determiner 310 generates and transmits a message to the server 200 upon the receipt of confirmation that the activity has been initiated. Particularly, the message is transmitted to the activity manager 240 of the server 200, which then stores the confirmation in the compliance activity database 210. Accordingly, a record of the initiation of the compliance activity is automatically generated and stored in the compliance activity database 210. In one example, the compliance activity database 210 stores the time at which the compliance activity was initiated.

In one example, the location determiner 310 ceases determining the location of the in-store device 300 upon receipt of confirmation that the activity has been completed. FIG. 3C shows an example of the user interface 350 displaying a screen which is configured to receive user input confirming that the compliance activity has been completed. In the example shown in FIG. 3C, the member of staff 13 presses the “YES” button to confirm that they have completed the compliance activity.

Next, the location determiner 310 generates and transmits a message to the server 200 including the generated location information. The activity manager 240 then receives the message and stores the location information in the compliance activity database 210. Accordingly, a record of the movements of the member of staff 13 is generated and stored in the compliance activity database 210, which serves as evidence that the activity has been completed. In one example, the compliance activity database 210 also stores the time at which the compliance activity was completed.

In the event that the activity manager 240 does not receive timely confirmation that the activity has been completed, the activity manager 240 generates an alert. For example, the compliance database 210 may store a maximum duration that the activity should take, and the activity manager 240 generates the alert if that duration is exceeded. The duration may be calculated from transmission of the instruction or receipt of the confirmation that the activity has been initiated. In one example, the alert is sent to the in-store device 300 and displayed on the user interface 350. FIG. 3D shows an example of the user interface 350 displaying such an alert.

In a further example, the alert is alternatively or additionally sent to a further in-store device (not shown) operated by another member of store staff, for example a supervisor or manager of the member of store staff 13. Accordingly, the supervisor or manager may then undertake remedial action to ensure that the activity is completed.

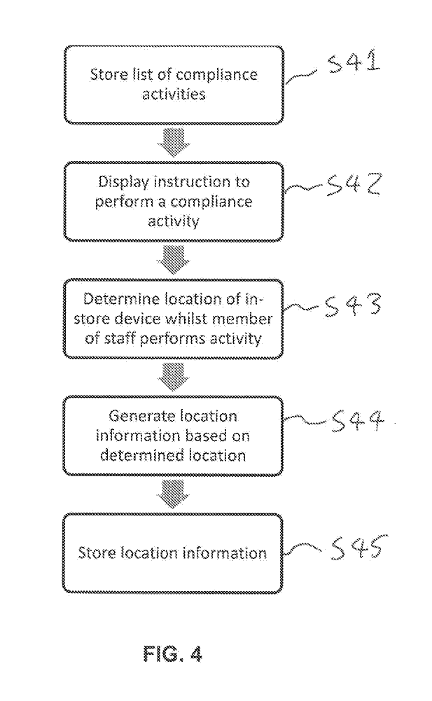

FIG. 4 is a flowchart of an exemplary method of monitoring an activity performed by a member of staff in a retail environment.

The method includes the step S41 of storing a list of activities to be performed by the member of staff. In one example, the list of activities is stored in a compliance database 210 of a server 200.

The method includes the step S42 of displaying an instruction to perform an activity from the list of activities on an in-store device carried by the member of staff whilst performing the activity. In one example, the in-store device is the in-store device 300 described above.

The method includes the step S43 of determining a location of the in-store device whilst the member of staff carries out the activity. In one example, the location is determined by a location determiner 310 of the in-store device 300.

The method includes the step S44 of generating location information based on the determined location. In one example, the location determiner 310 generates a list of co-ordinates representing the position of the in-store device 300 over time.

The method includes the step S45 of storing the location information of the in-store device 300. The location information serves as evidence that the activity has been completed. In one example, the in-store device 300 transmits the location information to the server 200, which then stores the location information in the compliance activity database 210.

In a further exemplary embodiment, the system 100 is operable to verify that the compliance activity has been completed. Particularly, the system 100 may capture environment data reflecting the physical state of a relevant part of the retail store 10 using one or more sensors, in order to verify that an activity has actually been completed.

Returning to FIG. 2, the system 100 further comprises a sensor array 400 and a compliance verifier 230. The sensor array 400 is configured to capture environment data of the retail store 10. The compliance verifier 230 is configured to determine whether the compliance activity has been completed, based on the captured environment data.

The sensor array3D400 comprises a plurality of sensors 410. Each sensor 410 is configured to capture environment data of a particular portion of the store. For example, a sensor 410 may be configured to capture environment data of a particular aisle 11, a particular storage unit 12, and/or a particular piece of retail store infrastructure, such as a fire exit door 14.

In one example, the or each sensor 410 comprises a 3D scanning device. The 3D scanning device is configured to scan the interior of the retail store 10. In one example, the 3D scanning device is a laser range finding device, configured to emit a pulse of light, receive the reflection of the emitted pulse from the surface of an object (e.g. a storage unit 12), and calculate the distance from the 3D scanning device to the object based on the round-trip time of the pulse. The 3D scanning device may calculate the distance of a large number of points (for example, millions or billions of points), thereby forming a point cloud which represents the scanned area.

In one example, the 3D scanning device is a stationary 3D scanning device, placed in a fixed position within the retail store 10 so as to capture a scan. For example, the device may be mounted to the ceiling of the store 10, or some other convenient vantage point which allows the device to scan the portion of the retail store 10 which is of interest. In one example, the 3D scanning device may be configured to be movable within the retail store 10. For example, the 3D scanning device may be mounted on rails (not shown) in the ceiling of the store 10, so as to be conveyed along a predetermined path whilst scanning. In one example, the 3D scanning device is a portable scanner, which may be held by a user whilst in use. It will be understood that the sensor array may comprise a mixture of the above-mentioned types of scanning device.

In one example, the 3D scanning device may comprises a model generation unit (not shown) configured to generate a 3D model from the scan data. The environment data comprises the generated 3D model. In one example, the model generation unit creates a polygonal mesh, in which the points of the point cloud are filled with polygons, such as triangles. In one example, the model generation unit is configured to apply a 3D model simplification algorithm, which reduces the number of surfaces present in the model in order to reduce processing overheads, whilst still retaining sufficient detail in the model to accurately capture the relevant environment data.

In one example, the or each sensor 410 comprises a camera configured to capture an image of the retail store 10. The environment data comprises a captured image.

In one example, the or each sensor 410 comprises a distance sensor configured measure a distance to the nearest object in a predetermined measurement direction. The environment data comprises the distance measurement. In one example, the sensor 410 comprises an emitter (not shown) and a receiver (not shown). The emitter emits a signal, and the receiver measures the quantity of the emitted signal which is reflected by the object. The receiver may also be configured to calculate the time elapsed between signal emission and receipt of the reflection. The sensor is configured to calculate the distance based on the measured quantity and/or the time elapsed.

In one example, the sensor 410 is a visible light sensor. In the example, the emitter comprises at least one LED configured to broadcast a signal comprising modulated visible light towards the object, and the receiver comprises a photo receiver configured to receive and measure the modulated visible light. In one example, the emitter is an LED light fixture produced by ByteLight™.

In a further example, the sensor 410 is a laser rangefinder sensor. In the example, emitter is configured to emit a laser pulse towards the object, and the receiver is a sensor configured to receive and measure the reflected laser pulse.

In a further example, the sensor 410 is an ultrasonic rangefinder sensor. In the example, emitter is configured to emit an ultrasonic pulse towards the object, and the receiver is a sensor configured to receive and measure the reflected sound wave.

In one example, the or each sensor 410 is a contact or proximity sensor configured to determine the position or configuration of an object. For example, the sensor 410 may be configured to sense whether a door or window is in an open or shut position.

It will be understood that the sensor array 400 may comprise a mixture of sensor types. It will be further understood that differing sensor technologies could also be employed where appropriate.

In one example, the sensor array 400 is coupled to the compliance verifier 230 by a suitable communication network 102. The communication network 102 may take any suitable form, including secure wired and/or wireless communication links, as will be familiar to those skilled in the art.

In one example, the server 200 comprises the compliance verifier 230. The compliance verifier 230 may be coupled to the sensor array via the communication unit 220. In one example, the communication network 102 may be the same network as the communication network 101.

The compliance verifier 230 is configured to determine whether the compliance activity has been completed based on the captured environment data, and to generate compliance verification information based on the determined activity completion. The compliance verifier 230 is further configured to store the compliance verification information in the compliance activity database 210.

In one example, the compliance verifier 230 determines whether the compliance activity has been completed by comparing the captured environment data to stored environment data, also referred to as baseline environment data. The baseline environment data represents what the environment data should be after the activity has been completed. Accordingly, if the captured environment data is the same as, or within a predetermined range of, the baseline environment data the compliance verifier 230 determines that the activity has been completed. If, on the other hand, the captured environment data is different from, or outside the predetermined range of, the baseline environment data, the compliance verifier 230 determines that the activity has not been completed.

In examples where the environment data comprises a 3D model, the compliance verifier 230 is configured to identify regions of difference between the captured 3D model and the baseline 3D model. If the regions of difference do not exceed a predetermined tolerance, the compliance verifier 230 is configured to determine that the activity is completed.

In examples where the environment data comprises an image, the compliance verifier 230 is configured to compare the captured image and the baseline image and identify differences therebetween. It will be understood that suitable computer vision algorithms—e.g. object detection—may be employed to pre-process the images in order to effect a more reliable comparison. If the differences do not exceed a predetermined tolerance, the compliance verifier 230 is configured to determine that the activity is completed.

In examples where the environment data comprises a distance measurement, the compliance verifier 230 is configured to compare the captured distance measurement with a baseline distance measurement. If the difference therebetween is with a predetermined range or tolerance, the compliance verifier 230 determines that the activity is completed.

In one example, the baseline environment data is stored in a baseline database (not shown) of the server 200. In one example, the baseline environment data is generated by capturing environment data when it is known that the relevant portion of the retail store 10 is in a compliant state.

In a further example, the compliance verifier 230 is configured to determine the position or configuration of an object in the retail store 10 based on the output of the sensor array 400, and to generate the compliance verification information based on the determined position. For example, the compliance activity may be that of shutting an open fire door 14, and the sensor array 400 may comprise a contact sensor 410 which outputs a first signal when the door 14 is shut and a second signal when the door 14 is open. Accordingly, the compliance verifier 230 may determine that the door 14 is shut based on the signal alone, without the need to refer to baseline environment data. In one example, the generated compliance verification information includes the position or configuration of the object before and after the compliance activity is performed by the member of staff 13.

In one example, the activity manager 240 is configured to control the compliance verifier 230 to verify the completion of the activity when the activity manager 240 receives the location information from the in-store device 300. In one example, the activity manager 240 is configured to control the compliance verifier 230 to verify the completion of the activity when the activity manager 240 receives the confirmation that the activity has been completed from the in-store device 300.

In one example, the activity manager 240 is further configured to generate an alert if the compliance verifier 230 determines that the activity has not been successfully completed. In one example, the alert is sent to the in-store device 300 and displayed on the user interface 350. In a further example, the alert is alternatively or additionally sent to a further in-store device (not shown) operated by another member of store staff, for example a supervisor or manager of the member of store staff 13. Accordingly, the supervisor or manager may then undertake remedial action to ensure that the activity is completed.

In use, the system 100 operates as described above until the point at which the location information and/or a confirmation that the activity has been completed is received by the activity manager 240 from the in-store device 300.

At that point, the activity manager 240 controls the compliance verifier 230 to verify that the activity has been completed. The compliance verifier 230 then captures environment data of the portion of the retail store 10 relating to the compliance activity, using the sensor array 400.

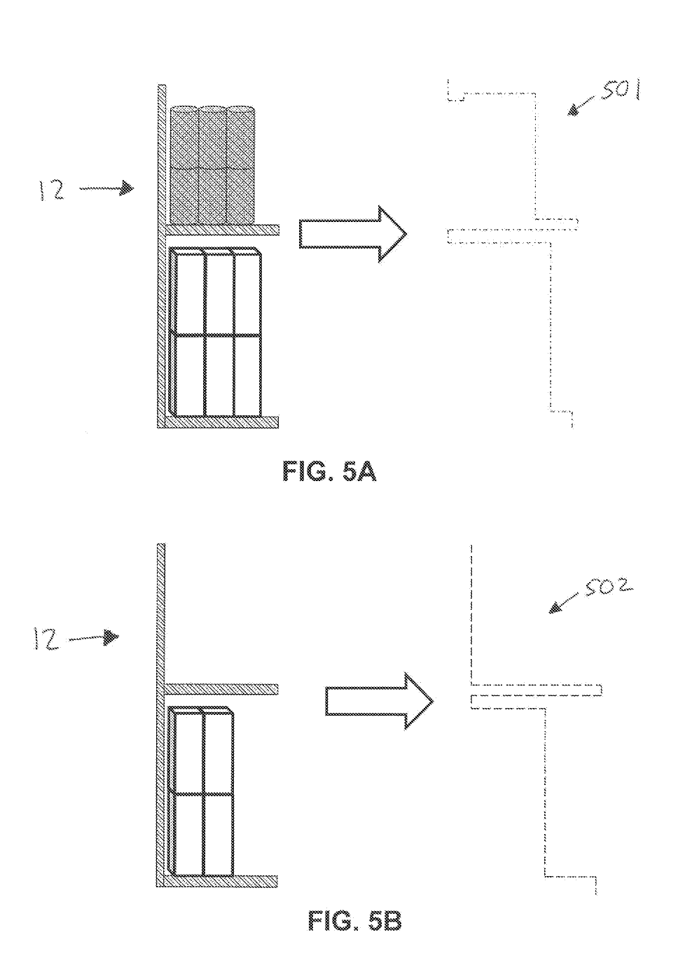

Next, the compliance verifier 230 determines whether the activity has been completed using the captured environment data. In one example, the compliance verifier 230 makes the determination by comparing the captured environment data to baseline environment data. An example comparison based on 3D models is described below with reference to FIG. 5.

FIG. 5A shows an example of a baseline 3D model 501 of a storage unit 12. In this example, the baseline 3D model reflects the storage unit 12 in a fully stocked state. Over time, the items are removed from the storage unit 12 by customers, and therefore instructions regarding compliance activity of restocking the storage unit 12 may be transmitted to the in-store device 300. If the 3D model captured after completion of the activity substantially corresponds to the baseline 3D model 501, then it is determined that the activity has been successfully completed.

FIG. 5B shows an example of a captured 3D model 502 of the storage unit 12, when the activity has not been successfully completed, because the upper shelf has not been refilled. In such an example, the compliance verifier 230 determines that the captured environment data 502 does not sufficiently correspond to the baseline 501, and therefore it is determined that the activity has not been successfully completed.

It will be understood that the inventive concepts are not limited to embodiments referred to herein, and that an analogous process may take place for the comparison of environment data which comprises images or distance measurements rather than 3D models.

In further examples, the compliance verifier 230 may determine the configuration or position of an object within the retail store, e.g. whether a door or window is open or closed, based on the output of the sensor array 400. For example, a contact or proximity sensor may be installed on a door which indicates that it is open or closed. In such examples, comparison to a baseline may not be required to determine the configuration or position.

Next, the compliance verifier 230 generates compliance verification information based on the determined activity completion. In one example, the verification information may comprise the captured environment data.

Next, the compliance verification information is stored in the compliance database 210. Accordingly a record is generated which confirms that the activity has actually been completed.

The above-described systems and methods may advantageously allow a retail store to conveniently ensure that compliance activities are carried out correctly and in a timely fashion. Furthermore, the above-described systems and methods advantageously generate information which serves as evidence that compliance activities have been successfully completed.

It will be appreciated that retail store staff may have a wide variety of skills and backgrounds, and the above-described embodiments provide a simple and intuitive system which may be operated with minimal training.

Accordingly, the burden of complying with the extensive rules and regulations that govern retail store operations may be alleviated, freeing up resource for other activities. Furthermore, the above-described systems and methods may serve to provide an environment for shoppers which is both safer and more conducive to the sale of goods.

1. A system for monitoring an activity performed by a member of staff in a retail environment, comprising:
a compliance activity database, configured to store a list of activities to be performed by the member of staff and location information associated with each activity on the list;
an in-store device, configured to display an instruction to perform an activity from the list of activities, and to be carried by the member of staff whilst performing the activity, and
a location determiner, configured to determine a location of the in-store device whilst the member of staff carries out the activity, generate location information based on the determined location and store the location information in the compliance activity database, wherein the location information serves as evidence that the activity has been completed.

2. The system of claim 1, comprising:
at least one sensor, configured to capture environment data of the retail environment, and
a compliance verifier, configured to determine whether the activity has been completed by the member of staff based on the environment data, and generate compliance verification information based on the determined activity completion,
wherein the compliance activity database is further configured to store compliance verification information associated with each activity on the list.

3. The system of claim 2, wherein the compliance verifier is configured to determine whether the activity has been completed by comparing the captured environment data to stored environment data,
wherein the stored environment data comprises baseline environment data representing the retail environment after completion of the activity.

4. The system of claim 2, wherein the or each sensor comprises a 3D scanner, and the environment data comprises a 3D model of the retail environment.

5. The system of claim 2, wherein the or each sensor comprises a camera, and the environment data comprises an image of the retail environment.

6. The system of claim 2, wherein the or each sensor comprises a laser distance sensor, and the environment data comprises a distance measurement.

7. The system of claim 2, wherein the compliance verifier is configured to determine a position or configuration of an object in the retail environment, and
the compliance verification information comprises the determined position or configuration of the object before the activity is performed and the determined position or configuration of the object after the activity is performed.

8. The system of claim 2, wherein the in-store device is configured to receive, by a user input, a completion confirmation indicating that the activity has been completed by the member of staff, and
the compliance verifier is configured to determine whether the activity has been completed upon receipt of the completion confirmation.

9. The system of claim 2, wherein, if the compliance verifier determines that the activity has not been completed, the in-store device is configured to display a non-compliance alert which indicates the activity has not been completed.

10. The system of claim 2, further comprising a supervisor device configured to be carried by a store supervisor,
wherein, if the compliance verifier determines that the activity has not been completed, the supervisor device is configured to display a non-compliance alert which indicates the activity has not been completed.

11. The system of claim 1, wherein the activity is a compliance activity, in which the member of staff ensures that that the retail environment complies with a relevant safety rule or regulation.

12. The system of claim 1, wherein the location determiner comprises:
a plurality of emitters operable to emit modulated light, and
a receiver operable to measure a quantity of modulated light received from each respective emitter, so as to determine the location,
wherein the in-store device comprises the receiver.

13. The system of claim 1, wherein the location information comprises a plurality of locations determined whilst the member of staff carries out the activity.

14. The system of claim 13, wherein the plurality of locations are determined at pre-determined time intervals.

15. The system of claim 1, wherein the in-store device is configured to receive, by a user input, a completion confirmation indicating that the activity has been completed by the member of staff, and
the compliance activity database is configured to store the completion confirmation.

16. The system of claim 1, wherein the in-store device is configured to receive, by a user input, an initiation confirmation indicating that the activity has been started by the member of staff, and
the compliance activity database is configured to store the initiation confirmation.

17. A method of monitoring an activity performed by a member of staff in a retail environment, comprising:
storing a list of activities to be performed by the member of staff;
displaying an instruction to perform an activity from the list of activities on an in-store device carried by the member of staff whilst performing the activity;
determining a location of the in-store device whilst the member of staff carries out the activity and generating location information based on the determined location, and
storing the location information of the in-store device, wherein the location information serves as evidence that the activity has been completed.

18. The method of claim 17, further comprising:
capturing environment data of the retail environment;
determining whether the activity has been completed by the member of staff based on the environment data;
generating compliance verification information based on the determined activity completion, and
storing the generated compliance verification information.

19. The method of claim 18, wherein the determining whether the activity has been completed comprises:
comparing the captured environment data to stored environment data,
wherein the stored environment data comprises baseline environment data representing the retail environment after completion of the activity.

20. The method of claim 18, wherein the determining whether the activity has been completed comprises:
determining a position or configuration of an object in the retail environment, wherein
the compliance verification information comprises the determined position or configuration of the object before the activity is performed and the determined position or configuration of the object after the activity is performed.
